(19) United States
(12) Patent Application Publication
(10) Pub. No.: US 2025/0044613 A1
(43) Pub. Date: Feb. 6, 2025

(54) Eyeglasses Device for Head Surgery Patients

(71) Applicants: Paulo Alexandre Porfirio, Palm Harbor, FL (US); Denise Gomes Nasciment Porfirio, Palm Harbor, FL (US)

(72) Inventors: Paulo Alexandre Porfirio, Palm Harbor, FL (US); Denise Gomes Nasciment Porfirio, Palm Harbor, FL (US)

(21) Appl. No.: 18/428,014

(22) Filed: Jan. 31, 2024

Related U.S. Application Data
(60) Provisional application No. 63/517,650, filed on Aug. 4, 2023.

(51) Int. Cl. G02C 3/00; G02C 5/14

(52) U.S. Cl. CPC G02C 3/003; G02C 5/14

(57) ABSTRACT

An eyeglasses device for head surgery patients is provided. The device is primarily comprised of a frame that may cover the eyes of a user such that the eyes may look through lenses of any kind. The frame is supported via a nosepiece and an arm that extends to the ear of the user. The device is comprised of only a single arm, allowing a side face area that may have been recently operated upon to not be irritated by the placement of glasses onto the face of the user. A strap, in one embodiment, may wrap around the head, providing additional support for the device.

### CROSS-REFERENCE TO RELATED APPLICATION

The present application claims priority to, and the benefit of, U.S. Provisional Application No. 63/517,650, which was filed on Aug. 4, 2023, and is incorporated herein by reference in its entirety.

### FIELD OF THE INVENTION

The present invention relates generally to the field of eyewear. More specifically, the present invention relates to an eyeglasses device for head surgery patients wherein the device is comprised of only a single arm, allowing a side area of a user's head/face that may have been recently operated upon to not be irritated by the placement of an eyeglasses frame on said area. Accordingly, the present disclosure makes specific reference thereto. Nonetheless, it is to be appreciated that aspects of the present invention are also equally applicable to other like applications, devices, and methods of manufacture.

### BACKGROUND

Individuals who have recently undergone a significant medical procedure involving their head or face, such as surgery, might find themselves grappling with the aftereffects, including irritated skin manifested through stitches, scarring, and other forms of discomfort. This situation becomes particularly challenging if the person desires to or must wear eyeglasses, sunglasses, etc. The typical design of eyeglasses includes arms that extend over the ears and rest along the sides of the head. In cases where the skin around these areas is tender or healing from surgical procedures, the constant contact and pressure exerted by the eyeglass arms can lead to significant discomfort. Although the use of eyeglasses is often essential for daily activities, this can result in a dilemma where the necessary act of wearing glasses becomes a source of constant pain and frustration.

Therefore, there exists a long-felt need in the art for a device that allows a user who has undergone a head or facial procedure to wear eyeglasses. There also exists a long-felt need in the art for an eyeglasses device for head surgery patients. More specifically, there exists a long-felt feed in the art for an eyeglasses device for head surgery patients wherein the device provides a pair of eyeglasses that does not irritate a head/face area of the user with a frame arm.

The subject matter disclosed and claimed herein, in one embodiment thereof, comprises an eyeglasses device for head surgery patients. The device is comprised of an eyeglass frame with a singular arm that extends from the frame to the top of an ear of the user (on only one side of the user's head/face). In one embodiment, at least one strap may attach to the frame and wrap around the head of the user, providing additional support and stability while providing support that is less irritating than a frame arm.

In this manner, the eyeglasses device for head surgery patients of the present invention accomplishes all the foregoing objectives and provides a device that allows a user who has undergone a head or facial procedure to wear eyeglasses. More specifically, the device provides a pair of eyeglasses that does not irritate a head/face area of the user with a frame arm which can be used by patients who have recently undergone a head/face procedure.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an eyeglasses device for head surgery patients primarily comprised of a frame, an arm, and a lens. The device is designed to rest on the nose and a single ear of a head surgery patient such that a patient with poor eyesight may wear glasses without causing pain or discomfort to the area at which the procedure occurred.

The device is comprised of a frame that may resemble any commonly used glasses frame style used in any commonly used application. The frame is further comprised of an arm that extends from the frame to the top of an ear of a user to provide support. The frame may be further supported via a nosepiece that rests on the nose of the user. The frame is further comprised of at least one lens that may provide protection from the sun, clearer vision, or simply an aesthetic purpose.

In one potential embodiment of the device, the device may be further comprised of at least one strap that may wrap around the head of the user. The strap is preferably elastic and may change its length via an adjustment fastener that allows the strap to fit around a head of any size and shape. The strap may be secured to the arm of the frame or the frame itself via a fastener on each end of the strap.

The present invention is also comprised of a method of using the device. First, a device is provided primarily comprised of a frame, an arm, and a strap. Then, a fastener of the strap is attached to the arm of the frame and the other fastener of the strap is attached to the frame. Then, the frame is placed on the head of the user such that the arm rests on an car of the user and a nosepiece of the frame rests on the nose of the user. Next, the strap may be adjusted to fit around the head of the user such that the strap rests on the other car of the user. Then, the adjustment fastener of the strap may be adjusted to fit securely and comfortably around the head of the user

Accordingly, the eyeglasses device for head surgery patients of the present invention is particularly advantageous as it provides a device that allows people with insufficient eyesight to see more clearly after a medical procedure on the head. More specifically, the eyeglasses device for head surgery patients can universally fit a head of any size and shape. Furthermore, the eyeglasses device for head surgery patients may only rest on a single car, providing vision without irritating any post-surgical side face area. In this manner, the eyeglasses device for head surgery patients overcomes the limitations of existing eyeglasses known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a strapless potential embodiment of an eyeglasses device for head surgery patients of the present invention in accordance with the disclosed architecture;

FIG. 2 illustrates a perspective view of a strapless potential embodiment of an eyeglasses device for head surgery patients of the present invention while worn by a user in accordance with the disclosed architecture;

FIG. 3 illustrates a perspective view of a strapped potential embodiment of an eyeglasses device for head surgery patients of the present invention in accordance with the disclosed architecture;

FIG. 4 illustrates a perspective view of a strapped potential embodiment of an eyeglasses device for head surgery patients of the present invention while worn by a user in accordance with the disclosed architecture; and

FIG. 5 illustrates a flowchart of a method of using one potential embodiment of an eyeglasses device for head surgery patients of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user who has undergone a head or facial procedure to wear eyeglasses. There also exists a long-felt need in the art for an eyeglasses device for head surgery patients. More specifically, there exists a long-felt feed in the art for an eyeglasses device for head surgery patients wherein the device provides a pair of eyeglasses that does not irritate a head/face area of the user with a frame arm.

The present invention, in one exemplary embodiment, is comprised of an eyeglasses device for head surgery patients. The device is primarily comprised of a frame, at least one arm, and a lens. The device is designed to rest on the nose and a single car of a head surgery patient such that a patient with poor eyesight may wear glasses without causing pain or discomfort to the area at which the procedure occurred.

More specifically, the device is comprised of a frame. The frame may resemble any commonly used glasses frame style and may be used in various differing applications, such as sunglasses, prescription, reading, etc. The frame may be further comprised of at least one arm that extends from the frame to mount onto the car of a user. The arm may be fixedly or removably attached to the frame via at least one hinge. The frame may be further comprised of a nosepiece that allows the device to sit comfortably on the nose of the user. In addition, at least one lens may be fixedly or removably attached to the frame, adjusting the eyesight of the user for the desired application: tinted, reading, general vision, etc.

In one potential embodiment, the device may be further comprised of at least one strap. The strap may fit around the head of the user, further securing the device to the head of the user. The strap may be made from any material but is preferably elastic and comfortable when resting against the skin. The strap may be further comprised of an adjustment fastener to shrink or extend the length of the strap to fit any head size. The strap is further comprised of a fastener on each end that allows the device to attach to the frame of the device. One end of the strap may be comprised of a fastener that allows the strap to attach to the arm of the frame and the other end of the strap may be comprised of a fastener that allows the strap to attach directly to the frame. Each fastener may be any fastener known in the art.

The present invention is also comprised of a method of using the device. First, a device is provided primarily comprised of a frame, an arm, and a strap. Then, a fastener of the strap is attached to the arm of the frame and the other fastener of the strap is attached to the frame. Then, the frame is placed on the head of the user such that the arm rests on an car of the user and a nosepiece of the frame rests on the nose of the user. Next, the strap may be adjusted to fit around the head of the user such that the strap rests on the other car of the user. Then, the adjustment fastener of the strap may be adjusted to fit securely and comfortably around the head of the user.

Accordingly, the eyeglasses device for head surgery patients of the present invention is particularly advantageous as it provides a device that allows people with insufficient eyesight to see more clearly after a medical procedure on the head. More specifically, the eyeglasses device for head surgery patients may rest on a single car of the user, not further irritating any side face area that has been recently operated upon. Furthermore, the eyeglasses device for head surgery patients can be universally fit to the head and shape of any person, no matter the size or shape of the head. In this manner, the eyeglasses device for head surgery patients overcomes the limitations of existing eyeglasses known in the art.

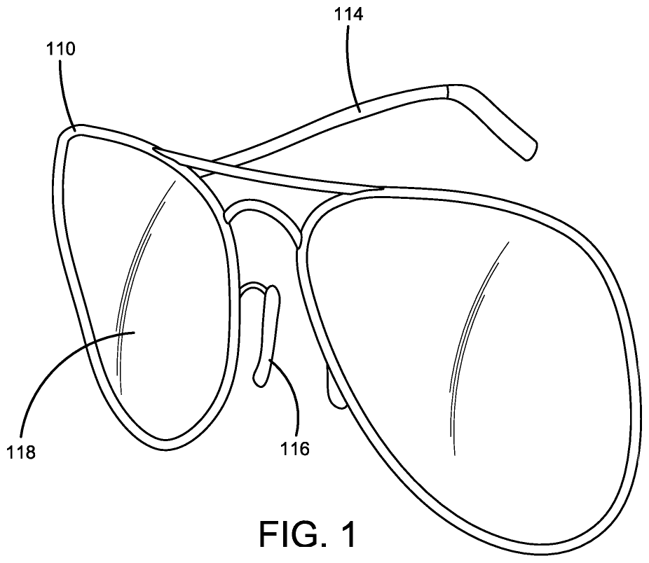

Referring initially to the drawings, FIG. 1 illustrates a perspective view of a strapless potential embodiment of an eyeglasses device for head surgery patients 100 of the present invention in accordance with the disclosed architecture. The device 100 is primarily comprised of a frame 110 with a singular frame arm 114, and at least one lens 118. The device 100 is designed to rest on the nose and above/on a single car of a head/face surgery patient such that the device does not cause pain or discomfort to the side head/face area 10 where the procedure occurred.

The device 100 is comprised of a frame 110. The frame 110 may resemble any commonly used glasses, sunglasses, safety glasses, etc., frame style such as, but not limited to, rectangle, square, round, cat-eye, aviator, oval, browline, oversized, geometric, etc. The frame 110 may also be made from any material from which eyeglass frames are commonly made. The frame 110 may be further comprised of a singular frame arm 114 (that may be positioned on the right or left side of the frame 110 in different embodiments) that extends from the frame 110 and rests on/above an car of the user. The arm 114 may be fixedly or removably attached to the frame 110 via at least one hinge 112. In the embodiment in which the arm 114 is removably attached to the frame 110, the arm 114 may be removed and reattached to the other side of the frame 110, using the other car of the user for support. This allows the user to position the arm 114 such that it rests on the side of the head/face 10 that was not operated on.

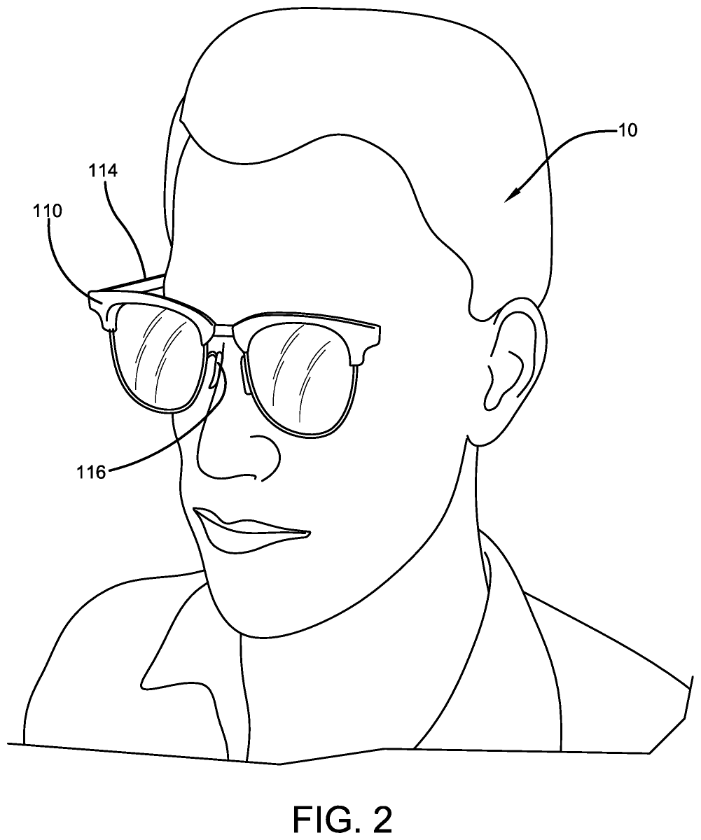

FIG. 2 illustrates a perspective view of a strapless potential embodiment of an eyeglasses device for head surgery patients 100 of the present invention while worn by a user in accordance with the disclosed architecture. The frame 110 may be further comprised of at least one nosepiece 116 (of any fixed or adjustable nose-piece style) that allows the device 100 to comfortably rest on the nose of the user for additional support. In one potential embodiment of the device 100, the frame 110 (or any area of the frame 110) may be counterweighted to prevent the frame 110 from incidentally rotating out of alignment with the eyes of the user. The frame 110 is further comprised of at least one, but preferably two, lens 118. The lens 118 may be unique to the intent of application by the user such that the lens 118 may be tinted to protect from sunlight, single vision lenses, bifocals, trifocals, aspheric lenses, progressive lenses, UV coated, etc.

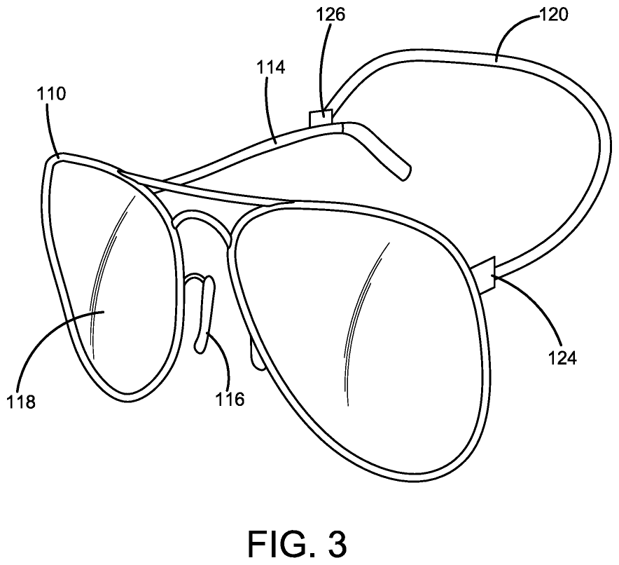

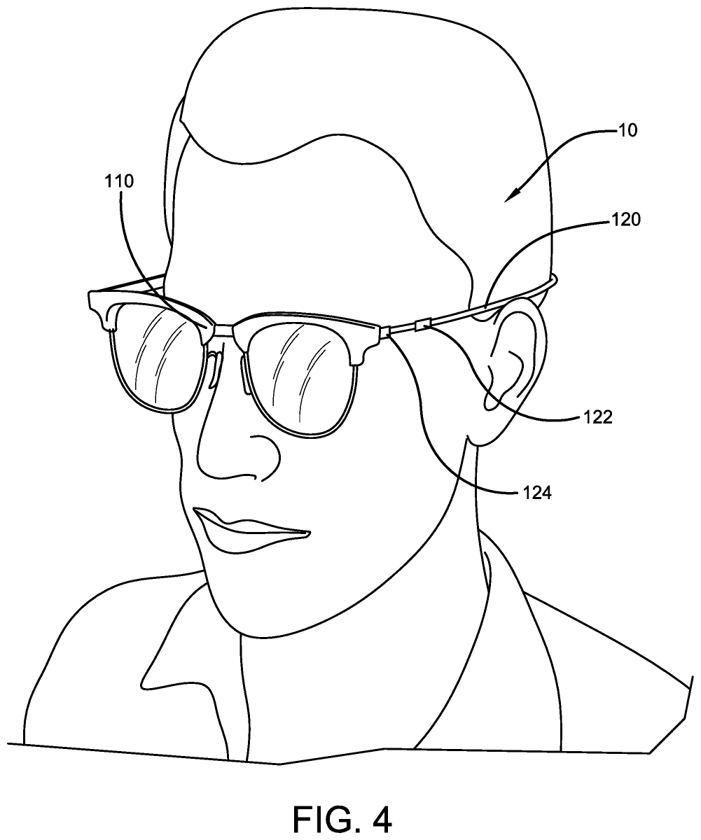

FIG. 3 illustrates a perspective view of a strapped potential embodiment of an eyeglasses device for head surgery patients 100 of the present invention in accordance with the disclosed architecture. In one potential embodiment, the device 100 may be further comprised of at least one strap 120. The strap 120 may fit around the head of the user to further secure the device 100 to/around the head of the user. The strap 120 preferably rests on the other car (i.e., the car on the side of the head/face 10 that was operated on) of the user, as best seen in FIG. 4. The strap 120 may be made from any material, but is preferably made from a flexible material (that may be padded) that is comfortable and non-irritating on the skin, such as, but not limited to, cotton, neoprene, silicone, rubber, etc. The strap 120 may further be comprised of an adjustment fastener 122 that allows the length of the strap 120 to be increased or decreased to fit around different-sized heads and provide different tightness levels. The strap 120 may also be comprised of at least one fastener 124, 126 on each end. A fastener 124 on one end of the strap 120 allows the strap 120 to attach to the frame 110 of the device 100. A fastener 126 on the other end of the strap 120 allows the strap 120 to attach to the arm 114 of the frame 110 of the device 100. Each fastener 124, 126 may be any fastener known in the art, such as, but not limited to, a clip, a latch, an adhesive, a snap-button, a hook-and-loop fastener, a tie, etc.

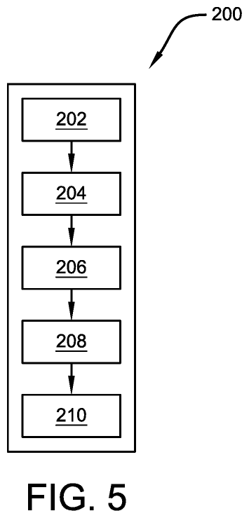

The present invention is also comprised of a method 200 of using the device 100, as seen in FIG. 5. First, a device 100 is provided primarily comprised of a strap 120 and a frame 110 with one frame arm 114 and at least one lens 118 [Step 202]. Then, a first fastener 126 of the strap 120 is attached to the arm 114 of the frame 110 and a second fastener 124 of the strap 120 is attached to the frame 110 directly [Step 204]. Then, the frame 110 is placed on the head of the user such that the arm 114 rests on an car (on a side of the user's head/face 10 that has not been operated on/injured) of the user and a nosepiece 116 of the frame 110 rests on the nose of the user [Step 206]. Next, the strap 120 may be adjusted to fit around the head of the user such that the strap 120 rests on, above, or around the other car or face area of the user (on the side of the user's head/face 10 that was operated on) [Step 208]. Then, an adjustment fastener 122 of the strap 120 may be adjusted to fit the device 100 securely and comfortably around the head of the user [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “eyeglasses device for head surgery patients” and “device” are interchangeable and refer to the eyeglasses device for head surgery patients 100 of the present invention.

Notwithstanding the foregoing, the eyeglasses device for head surgery patients 100 of the present invention and its various components can be of any suitable size and configuration as is known in the art without affecting the overall concept of the invention, provided that they accomplish the above-stated objectives. One of ordinary skill in the art will appreciate that the size, configuration, and material of the eyeglasses device for head surgery patients 100 as shown in the FIGS. are for illustrative purposes only, and that many other sizes and shapes of the eyeglasses device for head surgery patients 100 are well within the scope of the present disclosure. Although the dimensions of the eyeglasses device for head surgery patients 100 are important design parameters for user convenience, the eyeglasses device for head surgery patients 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An eyeglasses device for head surgery patients comprising:
an eyeglasses frame comprised of a single frame arm, a first lens, a second lens, and a nosepiece.

2. The eyeglasses device for head surgery patients of claim 1, wherein the first lens and the second lens are comprised of prescription lenses.

3. The eyeglasses device for head surgery patients of claim 1, wherein the first lens and the second lens are comprised of progressive lenses.

4. The eyeglasses device for head surgery patients of claim 1, wherein the first lens and the second lens are comprised of UV-coated lenses.

5. The eyeglasses device for head surgery patients of claim 1, wherein the nose piece is comprised of a fixed nosepiece.

6. The eyeglasses device for head surgery patients of claim 1, wherein the nose piece is comprised of an adjustable nosepiece.

7. An eyeglasses device for head surgery patients comprising:
an eyeglasses frame comprised of a single frame arm, a first lens, a second lens, and a nosepiece; and
a strap comprised of a first fastener and a second fastener.

8. The eyeglasses device for head surgery patients of claim 7, wherein the first fastener attaches to the frame arm.

9. The eyeglasses device for head surgery patients of claim 8, wherein the first fastener is comprised of a clip, a latch, an adhesive, a snap button, a hook and loop fastener, or a tie.

10. The eyeglasses device for head surgery patients of claim 7, wherein the first fastener attaches to the frame arm.

11. The eyeglasses device for head surgery patients of claim 10, wherein the first fastener is comprised of a clip, a latch, an adhesive, a snap button, a hook and loop fastener, or a tie.

12. The eyeglasses device for head surgery patients of claim 7, wherein the strap is comprised of a padded material.

13. The eyeglasses device for head surgery patients of claim 7, wherein the strap is comprised of an adjustment fastener.

14. The eyeglasses device for head surgery patients of claim 13, wherein the adjustment fastener allows the strap to increase and decrease in length.

15. The eyeglasses device for head surgery patients of claim 7, wherein the first lens and the second lens are comprised of prescription lenses.

16. The eyeglasses device for head surgery patients of claim 7, wherein the first lens and the second lens are comprised of progressive lenses.

17. The eyeglasses device for head surgery patients of claim 7, wherein the first lens and the second lens are comprised of UV-coated lenses.

18. The eyeglasses device for head surgery patients of claim 7, wherein the nose piece is comprised of a fixed nosepiece.

19. The eyeglasses device for head surgery patients of claim 7, wherein the nose piece is comprised of an adjustable nosepiece.

20. A method of using an eyeglasses device for head surgery patients, the method comprising the following steps:
providing an eyeglasses device for head surgery patients comprised of a strap and a frame comprised of a frame arm and a lens;
attaching the strap to the frame arm and the frame via a first fastener and a second fastener of the strap;
placing the frame around a user's head such that the arm rests on or above an ear of the user on a side of the user's head that was not operated on or injured; and
adjusting the strap such that the strap rests on, above, or around an ear on a side of the user's head that was operated on or injured.
